(19) United States
(12) Patent Application Publication
(10) Pub. No.: US 2022/0036751 A1
(43) Pub. Date: Feb. 3, 2022

(54) A METHOD AND A DEVICE FOR PROVIDING A PERFORMANCE INDICATION TO A HEARING AND SPEECH IMPAIRED PERSON LEARNING SPEAKING SKILLS

(71) Applicant: 4S Medical Research Private Limited, New Dehli (IN)

(72) Inventor: Shomeshwar Singh, New Dehli (IN)

(21) Appl. No.: 17/276,991

(22) PCT Filed: Oct. 31, 2019
(86) PCT No.: PCT/IN2019/050801

§ 371 Date: Mar. 17, 2021

(30) Foreign Application Priority Data
Dec. 31, 2018 (IN) 201811050125

(51) Int. Cl. G09B 5/02; G09B 21/00; G09B 19/04; G10L 21/10; G10L 15/02

(52) U.S. Cl. CPC G09B 5/02; G09B 21/009; G10L 2015/025; G10L 21/10; G10L 15/02; G09B 19/04

(57) ABSTRACT

The present invention describes a technique for providing a performance indication to a hearing and speech impaired person learning speaking skills. The technique comprises selecting a phoneme from a plurality of phonemes displayed on a display device; receiving a phoneme produced by the hearing and speech impaired person on a microphone; creating a first mathematical representation for the selected phoneme; creating a second mathematical representation for the received phoneme; generating a first visual equivalent representing the selected phoneme based on the first mathematical model; generating a second visual equivalent representing the received phoneme based on the second mathematical model; displaying the first visual equivalent and the second visual equivalent on the display device for the hearing and speech impaired person to compare; comparing the first mathematical representation and second mathematical representation; generating a performance indication based on result of a comparison of the first mathematical representation and second mathematical representation.

### CROSS-REFERENCE TO RELATED APPLICATIONS

This application is a national phase filing of International Application No. PCT/IN2019/050801, titled A METHOD AND A DEVICE FOR PROVIDING A PERFORMANCE INDICATION TO A HEARING AND SPEECH IMPAIRED PERSON LEARNING SPEAKING SKILLS, filed Oct. 31, 2019, which claims reference to Indian Application No. 201811050125, filed Dec. 31, 2018, the disclosures of which being expressly incorporated herein by reference.

### FIELD

The present disclosure generally relates to a speaking aid. More specifically, the present disclosure relates to converting speech efforts made by the hearing and speech-impaired person into a visual format enabling development of speech and correct pronunciation.

### BACKGROUND

The information in this section merely provide background information related to the present disclosure and may not constitute prior art(s).

Hearing aids have advanced significantly over the past decade due to improvement in the digital technologies. Now children born with severe deafness can be treated using advance technologies.

At present, children who are profoundly hearing impaired from birth can be treated effectively from the point of restoring their ability to hear and speak, only if intervention (surgery/hearing aids/cochlear implants/other auditory implants) is instituted before the age of 3-7 years. This is thought to be due to the brain's inability to retain neural plasticity with progressive age with respect to learning how to hear and therefore speak. Net result is that late intervention results in partial hearing restoration and consequently poor speech outcomes. As a result, no intervention is effective for curing the complete inability to hear and speak, after 3 to 7 years age.

Such persons then resort to using Sign Language and other such measures like gestures etc. to communicate. At present, intense speech therapy to teach them articulation skills to speak has met with very poor outcomes, primarily because in the absence of any feedback of their attempts to speak, they are unable to practice speaking adequately. Current electronic/computer-based speech therapy tools use visual feedbacks to help build individual speech skills like breath holding etc. but do not represent speech in its entirety.

Thus, the efforts and technologies currently available for teaching articulation skills of speaking to a deaf person are not found good enough to provide effective results.

Therefore, there is need in the art for improvements that overcome the above-mentioned problems and provides an advanced technology with a performance indication for hearing impaired persons to assist in speaking/pronunciation.

### SUMMARY OF THE DISCLOSURE

One or more shortcomings of the prior art are overcome, and additional advantages are provided by the present disclosure. Additional features and advantages are realized through the techniques of the present disclosure. Other embodiments and aspects of the disclosure are described in detail herein and are considered a part of the disclosure.

It is to be understood that the aspects and embodiments of the disclosure described above may be used in any combination with each other. Several of the aspects and embodiments may be combined together to form a further embodiment of the disclosure.

In an aspect, the present disclosure provides a method for providing a performance indication to a hearing and speech impaired person learning speaking skills. The method comprising: selecting a phoneme from a plurality of phonemes displayed on a display device; receiving a phoneme produced by the hearing and speech impaired person on a microphone; creating a first mathematical representation for the selected phoneme; creating a second mathematical representation for the received phoneme; generating a first visual equivalent representing the selected phoneme based on the first mathematical model; generating a second visual equivalent representing the received phoneme based on the second mathematical model; displaying the first visual equivalent and the second visual equivalent on the display device for the hearing and speech impaired person to compare; comparing the first mathematical representation and second mathematical representation; generating a performance indication based on result of a comparison of the first mathematical representation and second mathematical representation.

In another aspect, the present disclosure provides a method, wherein creating a first mathematical representation comprising: converting the selected phoneme into at least one of the following: formants, frequencies, spectral coefficients, cepstral coefficients.

In yet another aspect, the present disclosure provides a method, wherein creating a second mathematical representation comprising: converting the received phoneme into at least one of the following: formants, frequencies, spectral coefficients, cepstral coefficients.

In yet another aspect, the present disclosure provides a method, wherein generating a first visual equivalent comprises converting at least one of the following: formants, frequencies, spectral/cepstral coefficients of the selected phoneme into a color map.

In another aspect, the present disclosure provides a method, wherein generating a second visual equivalent comprises converting at least one of the following: formants, frequencies, spectral/cepstral coefficients of the received phoneme into a color map.

In yet another aspect, the present disclosure provides a method, wherein generating the performance indication comprises displaying a visual indication on the display device.

In an aspect, the present disclosure provides a device for providing a performance indication to a hearing and speech impaired person learning speaking skills. The device comprising an I/O interface (201), a display device (202), a transceiver (203), a memory (205), and a processor, wherein the processor (204) is configured to: receive a selection from a user of a phoneme from a plurality of phonemes displayed on the display device; receive a phoneme produced by the hearing and speech impaired person on a microphone; create a first mathematical representation for the phoneme selected by the user; create a second mathematical representation for the received phoneme; generate a first visual equivalent representing the selected phoneme based on the first mathematical model; generate a second visual equivalent representing the received phoneme based on the second mathematical model; display the first visual equivalent and the second visual equivalent on the display device for the hearing and speech impaired person to compare; compare the first mathematical representation and second mathematical representation; generate a performance indication based on result of a comparison of the first mathematical representation and second mathematical representation.

In another aspect, the present disclosure provides a device, wherein the processor is configured to create a first mathematical representation by: converting the selected phoneme into at least one of the following: formants, frequencies, spectral coefficients, cepstral coefficients.

In another aspect, the present disclosure provides a device wherein the processor is configured to create a second mathematical representation by: converting the received phoneme into at least one of the following: formants, frequencies, spectral coefficients, cepstral coefficients.

In another aspect, the present disclosure provides a device wherein the processor is configured to generate a first visual equivalent by converting at least one of the following: formants, frequencies, spectral/cepstral coefficients of the selected phoneme into color map.

In another aspect, the present disclosure provides a device, wherein the processor is configured to generate a second visual equivalent by converting at least one of the following: formants, frequencies, spectral/cepstral coefficients of the received phoneme into color map.

In another aspect, the present disclosure provides a device, wherein the processor is configured to generate the performance indication by displaying a visual indication on the display device.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of a system for providing a performance indication to a hearing and speech impaired person learning speaking skills according to an aspect of the present disclosure.

FIG. 2 illustrates a block diagram of an electronic device for implementing the technique described in FIGS. 1 and 3 according to an aspect of the present disclosure.

FIG. 3 illustrates a flowchart for describing a method for providing a performance indication to a hearing and speech impaired person learning speaking skills according to an aspect of the present disclosure.

### DETAILED DESCRIPTION

Referring in the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus or device. It could be noted with respect to the present disclosure that the terms like “speaking aid”, “visual equivalent”, “visual feedback”, are interchangeably used throughout the description and refer to the same speaking aid as described herein. Further, the terms like “user”, “a deaf person”, “a person with profound deafness”, “hearing impaired”, “hearing and speech impaired” refer to the same user who is trying to speak and improve using the present disclosure. Simultaneously, with respect to the present disclosure, terms like “performance indication” or “indication”, “score” are interchangeably used throughout the description and refers to the same performance indication as described herein.

According to an aspect of the present isclosure a “method and a device for providing a performance indication to a hearing and speech impaired person learning speaking skills” allows a deaf person to pronounce phonemes/words correctly and can show the results of his/her efforts visually to guide them for correctness, building his confidence, thereby providing encouragement to the person, as opposed to in the past, wherein, a hearing impaired person will invariably be dumb. Moreover, the present disclosure will make the hearing-impaired person self-reliant for better understanding of their pronounced words. The present disclosure achieves these advantage(s) in a manner as described below.

The present isclosure uses the brain's ability to process visual stimuli, that these hearing and speech impaired persons are exceptionally good at, since they use their visual skills to communicate. The disclosure utilizes a mathematical algorithm that converts a spoken sound into a set of numbers (coefficients, such as cepstral coefficients) which is usually a mathematical representation/model. These numbers are then represented on a color palate thereby allocating a specific color to a specific value. Collation of all these representative numbers and their colors on a screen results in a “Visual Equivalent” or a “color map” of the spoken sound.

According to an exemplary aspect of the present disclosure, a performance indication is provided to report back to the user as to whether he spoke a particular sound clearly or not. The present disclosure compares the result of the user's effort to the average of a number of normally pronounced sounds and scores the performance on a 1 to 10 score. This has further been simplified by representing this score in a simple intuitive red/orange/green light. However, the same should not be construed as limiting example to represent the score/performance indication. This score is analogous to a trainer reporting on the quality of ones' pronunciation.

It is worth noting that data encoded in the “Visual Equivalent” technique is very similar to what the brain receives from the inner ear in a normal hearing person, in that it is a mathematical representation of the spoken sound. Once the brain receives this feedback by way of visual equivalent and the performance indication, via the active visual cortex, training by regular practice will allow the user to develop speech.

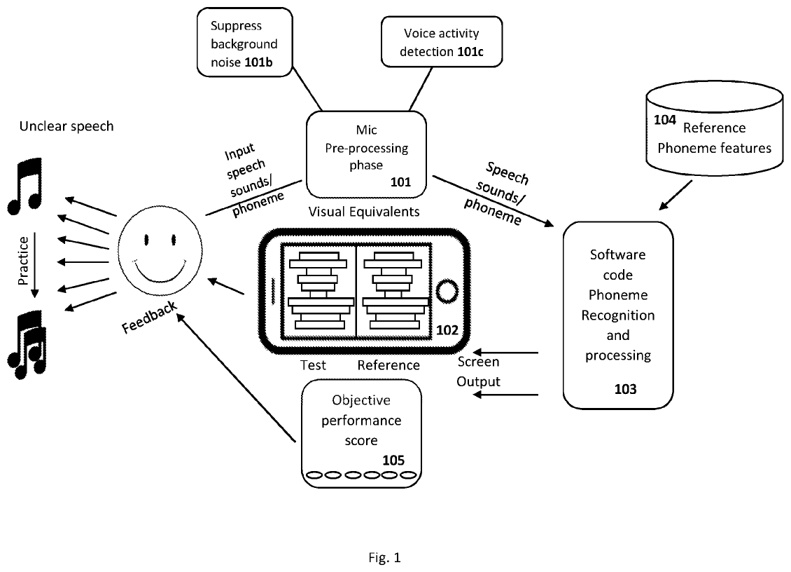

FIG. 1 refers to an embodiment of the presently disclosed disclosure that defines a system (100). Broadly, the system comprises a mic (101) or microphone unit, an electronic device (102), a phoneme recognition and processing unit (103), a database (104) comprising reference phoneme features and a performance score unit (105). The mic (101) comprises a pre-processing unit (101a) which further comprises of background noise suppressing unit (101b) and a voice activity detection unit (101c).

In operation, when a user attempts to speak, this voice input from the user is detected and processed by the mic (101) and associated pre-processing unit (101a) at the first stage. This phase comprises processes involved in detection of speech of the user and suppression of unwanted noise with this speech. The processed speech from the mic (101) is transmitted to the phoneme recognition and processing unit (103).

The phoneme recognition and processing unit (103) further comprises a processor (not shown in the fig.) for processing of various instructions including comparing the phonemes corresponding to user's voice input with the desired/reference phoneme or selected reference phoneme, a memory (not shown in fig.) to store data and instructions, fetched and retrieved by the processor. The desired/reference phoneme is the phoneme which the user wants to speak and is selected by the user. For reference, the phoneme recognition and processing unit (103) is in communication with the database (104) comprising various reference phoneme features with respect to user's voice input.

During the phoneme recognition and processing, the processor converts received sound into a mathematical representation/model and based on this mathematical representation, the processor generates a “visual equivalent” on a display of the electronic device (102). Simultaneously, the processor generates another “visual equivalent” of the desired/reference phoneme or selected reference phoneme at the display of the device (102). The display thus represents a reference or target “visual equivalent” or a “color map” of the desired/reference phoneme or selected reference phoneme voice input as well as a test or current “visual equivalent” of what the user has pronounced (user's voice input). While the present disclosure is described with reference to a color map as an example of the visual equivalent, the same should not be construed as a limiting example of displaying a visual equivalent on the display of device.

As already discussed, representing visual equivalents on the display of the electronic device is based on the algorithm that converts a spoken sound into a set of numbers (coefficients, such as cepstral coefficients). As the display of the electronic device displays both of the above said visual equivalents, the user can interpret how correctly he/she is pronouncing the words. In one of the exemplary embodiments, a phoneme recognition engine is used to create visual equivalents. Preferably, the phoneme recognition engine has been created using the C++ software platform. However, the same should not be construed as a limiting example. The phoneme recognition engine analyzes the cepstral coefficients of voice (phonemes) and also provides spectral parameters that have been used to create visual feedback entities (color maps) for enhanced visual feedback.

Based on the both the reference visual equivalent and the test visual equivalent, an objective performance score is generated by the processor and provided to the user by the performance score unit (105) or the performance indication unit. The performance indication unit (105) thus provides a visual indication to the user as to whether he made a sound clearly or not. The present disclosure compares the result of the user's effort to the average of several normally made sounds and scores the performance on a 1 to 10 score. This has further been simplified by representing this score in a simple intuitive red/orange/green light. This score is analogous to a trainer reporting on the quality of ones' pronunciation.

In one of the exemplary embodiments, the performance score unit (105) is an integral part of the device. Yet in another example, the performance score unit (105) is attached externally to the device. The act of feedback to the users on how well they made a sound or pronounced a word provides encouragement to the user. Thus, the feedback allows the required motivation which eventually results in clear speech.

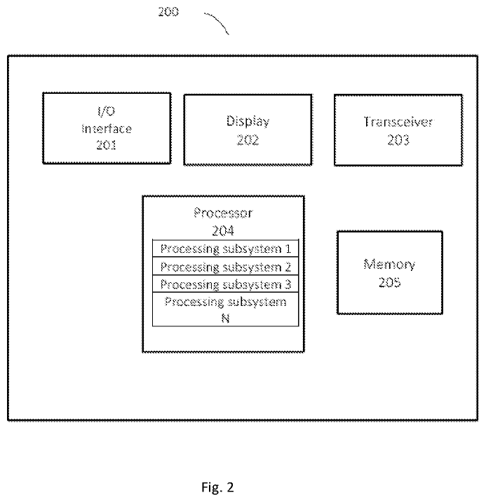

FIG. 2 illustrates an exemplary block diagram of an electronic device (200) which implements the present disclosure according to an aspect of the present disclosure. The examples of the electronic devices may include mobile devices, laptops, PDAs, palmtops and any other electronic device capable of implementing the present disclosure. The device (200) may comprise an I/O interface (201), a display (202), a transceiver (203), processor (204) and a memory (205).

The processor (204) may comprise at least one data processor for executing program components for dynamic resource allocation at run time. The processor (204) may include specialized processing units or sub systems such as integrated system (bus) controllers, memory management control units, floating point units, graphics processing units, digital signal processing units, etc.

Using the I/O interface (201), the device may communicate with one or more I/O devices. For example, the input device may be a keyboard, mouse, joystick, (infrared) remote control, camera, microphone, touch screen, etc.

The memory (205) may store a collection of program or database components, including, without limitation, an operating system, user interface, etc. In some embodiments, the device 200 may store user/application data, such as the data, variables, records, etc. as described in this disclosure. Each of above discussed components of the electronic device performs processes pertaining to this disclosure to achieve the desired aim.

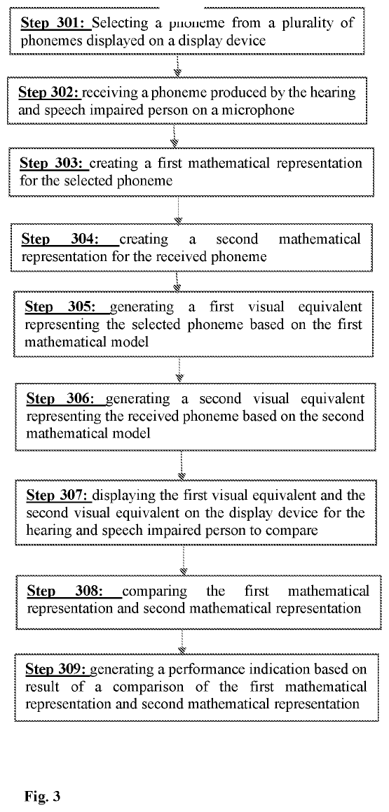

FIG. 3 illustrates a flowchart for describing a method for providing a performance indication to a hearing and speech impaired person learning speaking skills according to an aspect of the present disclosure.

At step 301, the user selects a phoneme from a plurality of phonemes displayed on a display of electronic device. This phoneme is the desired phoneme which the user wants to practice and learn.

At step 302, the hearing and speech impaired person produces a sound/phoneme (input speech signal) which is received at a microphone. At step 303, a first mathematical representation for the selected phoneme is created. Similarly, at step 304, a second mathematical representation for the received phoneme is created. To create the second mathematical representation, the processor breaks down the input speech signal into a number of cepstral coefficients which is preferably 13 in one of the non-limiting examples. In another exemplary embodiment, the first mathematical representation is created by way of any suitable number of coefficients. The processor revises these values every few milliseconds which is preferably 20 milliseconds, but not limited thereto, until the end of the spoken sound duration, with a maximum duration of one second. This is so because as the user begins to pronounce a particular phoneme, the sound generated changes in character continuously until the end of the pronunciation. Therefore, the processor needs to continuously evaluate the sound produced and the values used to describe the sound keeps changing. Revising the values every 20 milliseconds provides reasonable detail for a sound/phoneme which lasts about 1 second. It rejects any input speech longer than one second. These thirteen numbers defining the input sound, changing every few milliseconds form the basis of the mathematical model/representation constructed. The first mathematical model is created in a similar way by the processor.

At step 305, a first visual equivalent representing the selected phoneme is generated based on the first mathematical model. Similarly, at step 306, a second visual equivalent representing the received phoneme is generated based on the second mathematical model. At step 307, both the first and the second visual equivalents are displayed on the display device. The hearing and speech impaired person compares both the visual equivalents and thus can interpret correctness of the words pronounced by him. At step 308, the first mathematical representation and second mathematical representation are compared by the processor to generate a performance indication at step 309 as a result of the comparison. Each time the user tries to modulate his speech by looking and comparing at the visual equivalents, the performance indication score is accordingly provided.

In an exemplary embodiment, the first and the second mathematical representations are created by converting the selected phoneme/received phonemes into at least one of the following: formants, frequencies, spectral coefficients, cepstral coefficients.

In an exemplary embodiment, the first and the second visual equivalents are generated by converting at least one of the following: formants, frequencies, spectral/cepstral coefficients of the selected phoneme into a color map.

Accordingly, it should be understood that the present disclosure allows a deaf person to get a real time feedback on the correctness of his speech and helps him know if he is speaking close to what he chose to speak, thus helping him improve his performance. This is functionally very similar to a person who is not deaf learning to speak new sounds by hearing himself. The act of hearing essentially gives them a feedback on how well they made a sound or pronounced a word.

Thus, with the present disclosure a user can practice speaking a language clearly on his own and he would not necessarily need a guide/speech therapist to tell him how well he is speaking, because the present disclosure provides him a feedback (Objective Score and Visual Equivalents). This feedback provides the user with a motivation which eventually helps him in speaking a language clearly.

The foregoing description of the various embodiments is provided to enable any person skilled in the art to make or use the present disclosure. The inventors have developed the currently disclosed technique in such a way that it remains user friendly and improves the life and wellbeing of a section of human society. In fact, it is one of the unique efforts made by the inventors to develop a system as disclosed in the present disclosure for helping people who are having problem of hearing and therefore speaking.

Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein, and instead the embodiments should be accorded the widest scope consistent with the principles and novel features disclosed herein.

While the disclosure has been described with reference to a preferred embodiment, it is apparent that variations and modifications will occur without departing the spirit and scope of the disclosure. It is therefore contemplated that the present disclosure covers any and all modifications, variations or equivalents that fall within the scope of the basic underlying principles disclosed above.

1. A method for providing a performance indication to a hearing and speech impaired person learning speaking skills, the method comprising:
selecting, on a display device, a phoneme;
receiving, at a microphone, a phoneme produced by the hearing and speech impaired person;
creating a first mathematical model off the selected phoneme;
creating a second mathematical model off the received phoneme;
generating a first visual equivalent representing the selected phoneme based on the first mathematical model;
generating a second visual equivalent representing the received phoneme based on the second mathematical model;
displaying the first visual equivalent and the second visual equivalent on the display device for the hearing and speech impaired person to compare;
comparing the first mathematical model and second mathematical model;
generating a performance indication based on a result of the comparison of the first mathematical model and second mathematical model.

2. The method of claim 1, wherein creating the first mathematical model comprises:
converting the selected phoneme into at least one of the following: formants, frequencies, spectral coefficients, and cepstral coefficients.

3. The method of claim 1, wherein creating the second mathematical model comprises:
converting the received phoneme into at least one of the following: formants, frequencies, spectral coefficients, and cepstral coefficients.

4. The method of claim 1, wherein generating the first visual equivalent comprises converting at least one of the following: formants, frequencies, spectral coefficients and cepstral coefficients of the selected phoneme into a color map.

5. The method of claim 1, wherein generating the second visual equivalent comprises converting at least one of the following: formants, frequencies, spectral coefficients and cepstral coefficients of the received phoneme into a color map.

6. The method of claim 1, wherein generating the performance indication comprises displaying a visual indication on the display device.

7. The method of claim 1, wherein selecting a phoneme includes selecting the phoneme from a plurality of phonemes displayed on the display device.

8. A device for providing a performance indication to a hearing and speech impaired person learning speaking skills, comprising:
an I/O interface;
a display device;
a transceiver;
a memory; and
a processor;
wherein the processor is configured to:
receive a selection from a user on the display device of a phoneme;
receive from a microphone a phoneme produced by the hearing and speech impaired person;
create a first mathematical model off the phoneme selected by the user;
create a second mathematical model off the received phoneme;
generate a first visual equivalent representing the selected phoneme based on
the first mathematical model;
generate a second visual equivalent representing the received phoneme based
on the second mathematical model;
display the first visual equivalent and the second visual equivalent on the display device for the hearing and speech impaired person to compare;
compare the first mathematical model and second mathematical model;
generate a performance indication based on a result of a comparison of the first mathematical model and second mathematical model.

9. The device of claim 8, wherein the processor is configured to create the first mathematical model by
converting the selected phoneme into at least one of the following: formants, frequencies, spectral coefficients, and cepstral coefficients.

10. The device of claim 8, wherein the processor is configured to create the second mathematical model by
converting the received phoneme into at least one of the following: formants, frequencies, spectral coefficients, and cepstral coefficients.

11. The device of claim 8, wherein the processor is configured to generate the first visual equivalent by converting at least one of the following: formants, frequencies, spectral coefficients and cepstral coefficients of the selected phoneme into color map.

12. The device of claim 8, wherein the processor is configured to generate the second visual equivalent by converting at least one of the following: formants, frequencies, spectral coefficients and cepstral coefficients of the received phoneme into color map.

13. The device of claim wherein the processor is configured to generate the performance indication by displaying a visual indication on the display device.

14. The device of claim 7, wherein the selection of a phoneme is from a plurality of phonemes displayed on the display device.

15. A system for improving speech of a hearing impaired person, comprising:
a display configured to permit the person to select a phoneme;
a microphone configured to receive a phoneme produced by the person; and
a processor coupled to the display and the microphone, the processor being configured to:
receive the selected phoneme and the produced phoneme;
generate a first visual equivalent of the selected phoneme based on a first mathematical model;
generate a second visual equivalent of the produced phoneme based on a second mathematical model;
display the first and second visual equivalents for the person to compare;
compare the first and second mathematical models; and
display a performance indication on the display based on the comparison of the first and second mathematical models.

16. The system of claim 15, wherein the processor is configured to create the first mathematical model by converting the selected phoneme into at least one of the following: formants, frequencies, spectral coefficients, and cepstral coefficients.

17. The system of claim 15, wherein the processor is configured to create the second mathematical model by converting the received phoneme into at least one of the following: formants, frequencies, spectral coefficients, and cepstral coefficients.

18. The system of claim 15, wherein the processor is configured to generate the first visual equivalent by converting at least one of the following: formants, frequencies, spectral coefficients and cepstral coefficients of the selected phoneme into a color map.

19. The system of claim 15, wherein the processor is configured to generate the second visual equivalent by converting at least one of the following: formants, frequencies, spectral coefficients and cepstral coefficients of the received phoneme into a color map.

20. The system of claim 15, wherein the processor is configured to generate the performance indication by displaying a visual indication on the display.
